(19) United States
(12) Patent Application Publication
(10) Pub. No.: US 2019/0340095 A1
(43) Pub. Date: Nov. 7, 2019

(54) PREDICTING PERFORMANCE OF APPLICATIONS USING MACHINE LEARNING SYSTEMS

(71) Applicant: EMC IP HOLDING COMPANY LLC, Hopkinton, MA (US)

(72) Inventors: Sorin Faibish, Newton, MA (US); James M. Pedone, JR., West Boylston, MA (US); Philippe Armangau, Acton, MA (US)

(21) Appl. No.: 15/970,943

(22) Filed: May 4, 2018

(51) Int. Cl. G06F 11/34; G06N 99/00; G06F 11/30

(52) U.S. Cl. CPC G06F 11/3409; G06F 11/302; G06N 99/005

(57) ABSTRACT

A method is used in predicting performance of applications using machine learning systems. A machine learning system is trained on a sample server executing an application. An expected performance of the application is determined using the machine learning system for a server having different characteristics than the sample server by predicting the expected performance of the application on the server without having to actually measure a performance of the application on the server.

### BACKGROUND

### Technical Field

This application relates to predicting performance of applications using machine learning systems.

### Description of Related Art

Computer systems may include different resources used by one or more host processors. Resources and host processors in a computer system may be interconnected by one or more communication connections. These resources may include, for example, data storage devices such as those included in the data storage systems manufactured by EMC Corporation. These data storage systems may be coupled to one or more host processors and provide storage services to each host processor. Multiple data storage systems from one or more different vendors may be connected and may provide common data storage for one or more host processors in a computer system.

A host processor may perform a variety of data processing tasks and operations using the data storage system. For example, a host processor may perform basic system Input/Output (I/O) operations in connection with data requests, such as data read and write operations.

Host processor systems may store and retrieve data using a storage device containing a plurality of host interface units, disk drives, and disk interface units. Such storage devices are provided, for example, by EMC Corporation of Hopkinton, Mass. The host systems access the storage device through a plurality of channels provided therewith. Host systems provide data and access control information through the channels to the storage device and storage device provides data to the host systems also through the channels. The host systems do not address the disk drives of the storage device directly, but rather, access what appears to the host systems as a plurality of logical disk units, logical devices, or logical volumes. The logical disk units may or may not correspond to the actual disk drives. Allowing multiple host systems to access the single storage device unit allows the host systems to share data stored therein.

In connection with data storage, a variety of different technologies may be used. Data may be stored, for example, on different types of disk devices and/or flash memory devices. The data storage environment may define multiple storage tiers in which each tier includes physical devices or drives of varying technologies. The physical devices of a data storage system, such as a data storage array (or “storage array”), may be used to store data for multiple applications.

Data storage systems are arrangements of hardware and software that typically include multiple storage processors coupled to arrays of non-volatile storage devices, such as magnetic disk drives, electronic flash drives, and/or optical drives. The storage processors service I/O operations that arrive from host machines. The received I/O operations specify storage objects that are to be written, read, created, or deleted. The storage processors run software that manages incoming I/O operations and performs various data processing tasks to organize and secure the host data stored on the non-volatile storage devices.

### SUMMARY OF THE INVENTION

In accordance with one aspect of the invention is a method is used in predicting performance of applications using machine learning systems. The method trains a machine learning system on a sample server executing an application. The method determines an expected performance of the application using the machine learning system, for a server having different characteristics than the sample server, by predicting the expected performance of the application on the server without having to actually measure a performance of the application on the server.

In accordance with another aspect of the invention is a system is used in predicting performance of applications using machine learning systems. The system trains a machine learning system on a sample server executing an application. The system determines an expected performance of the application using the machine learning system, for a server having different characteristics than the sample server, by predicting the expected performance of the application on the server without having to actually measure a performance of the application on the server.

In accordance with another aspect of the invention, a computer program product comprising a computer readable medium is encoded with computer executable program code. The code enables execution across one or more processors for predicting performance of applications using machine learning systems. The code trains a machine learning system on a sample server executing an application. The code determines an expected performance of the application using the machine learning system, for a server having different characteristics than the sample server, by predicting the expected performance of the application on the server without having to actually measure a performance of the application on the server.

### BRIEF DESCRIPTION OF THE DRAWINGS

Features and advantages of the present technique will become more apparent from the following detailed description of exemplary embodiments thereof taken in conjunction with the accompanying drawings in which:

FIG. 1 an example of an embodiment of a computer system, in accordance with an embodiment of the present disclosure;

FIG. 2 is a block diagram of a computer, in accordance with an embodiment of the present disclosure;

FIG. 3 illustrates an example process to train the machine learning system, in accordance with an embodiment of the present disclosure;

FIG. 4 illustrates an example process to train a customer application model, in accordance with an embodiment of the present disclosure; and

FIG. 5 is a flow diagram illustrating processes that may be used in connection with techniques disclosed herein.

### DETAILED DESCRIPTION OF EMBODIMENT(S)

Described below is a technique for use in predicting performance of applications using machine learning systems, which technique may be used to provide, among other things, training a machine learning system on a sample server executing an application, and determining an expected performance of the application using the machine learning system, for a server having different characteristics than the sample server, by predicting the expected performance of the application on the server without having to actually measure a performance of the application on the server.

As described herein, in at least one embodiment of the current technique, a machine learning system is trained on a sample server that is executing an application. The trained machine learning system is then used to predict how the application will perform on a server that has different hardware and/or software characteristics than the sample server. As noted above, the machine learning system predicts an expected performance of the application executing on the server without having to measure the performance of the application on the server.

Conventional technologies cannot evaluate the new behavior of software applications and/or new features of storage arrays for all hardware and software platforms. Typically, new applications are tested on a few platforms (for example, the more powerful platforms), and the applications are then optimized for those few platforms. When released, the new applications will be executing on a variety of platforms that may have, for example, a different number of processor cores, different size memory, different networks and/or back-end pipes than the few platforms on which the applications were optimized. The alternative is to test the new applications on all combinations of hardware and software platforms. This is not feasible, and would only delay the release of the new applications, preventing all customers from being able to access the new applications.

Conventional technologies that test new applications on a few platforms may modify parameters that may benefit the few platforms, but may result in less optimal performance for other platforms and/or results that are unacceptable to the customers. For example, the result may be less efficient usage of the Central Processing Unit (CPU), the memory, or disk space. Thus, the installation of new applications may result in worse performance for some customers. This is an unacceptable outcome.

By contrast, in at least some implementations in accordance with the current technique as described herein, a machine learning system is trained on a sample server executing an application. The trained machine learning system is then used to predict an expected performance of the application executing on another server having different characteristics than the sample server, without having to measure a performance of the application executing on the server. Using the trained machine learning system to predict performance of an application on a server provides expected performance information of such application without having to install the application on the server.

Thus, in at least one embodiment of the current technique, the goal of the current technique is to accurately predict expected performance of an application executing on a server even before the application actually executes on the server. In at least one embodiment of the current technique, the machine learning system is trained on a few platforms on which an application is executed and performance data of the application is gathered, and the trained machine learning system is then used to predict the expected performance of the application when executed on a wide variety of hardware and software platforms. The expected performance may be predicted without having to install the application on the wide variety of hardware and software platforms. Once the application is installed, a measured performance may be compared to the expected performance to determine how to adjust (also referred to herein as “tune”) the parameters (e.g., configuration parameters) for particular platforms to optimize performance and/or behavior of the application. Thus, performance of a new application can be estimated for a wide variety of hardware and software platforms without testing the application on such wide variety of platforms thereby avoiding delaying release of the new application.

In at least some implementations in accordance with the current technique described herein, the use of predicting performance of applications using machine learning systems technique can provide one or more of the following advantages: predicting performance over a wide variety of hardware and software platforms without having to perform Quality Assurance testing across all of the various platforms regardless of the unique workload at each customer site, predicting performance of new applications and features prior to providing/installing the new applications and features, allowing customers to tune parameters for new applications and features prior to receiving/installing the new applications and features, providing developers with feedback regarding new applications and features prior to the release of those new applications and features, and allowing customers to create their own customized machine learning system.

In contrast to conventional technologies, in at least some implementations in accordance with the current technique as described herein, a method trains a machine learning system on a sample server executing an application. The method determines an expected performance of the application using the machine learning system, for a server having different characteristics than the sample server, by predicting the expected performance of the application on the server without having to actually measure a performance of the application on the server.

In an example embodiment of the current technique, the method determines whether the expected performance meets a performance threshold associated with the application executing on the server, prior to installing the application on the server.

In an example embodiment of the current technique, the method provides information to modify the application based on the expected performance of the application.

In an example embodiment of the current technique, the method compares the expected performance to a measured performance of the application executing on the server.

In an example embodiment of the current technique, the method updates configuration parameters associated with the application to adjust performance of the application according to the expected performance.

In an example embodiment of the current technique, the method continues to train the machine learning system using the measured performance.

In an example embodiment of the current technique, the method trains the machine learning system with performance testing data associated with the application gathered during execution of the application on a second server.

In an example embodiment of the current technique, the server having different characteristics than the sample server has at least one of different hardware characteristics and different software characteristics than the sample server.

In an example embodiment of the current technique, the method includes at least one parameter when determining the expected performance of the application, where the parameter was not included when the application was executing on the sample server.

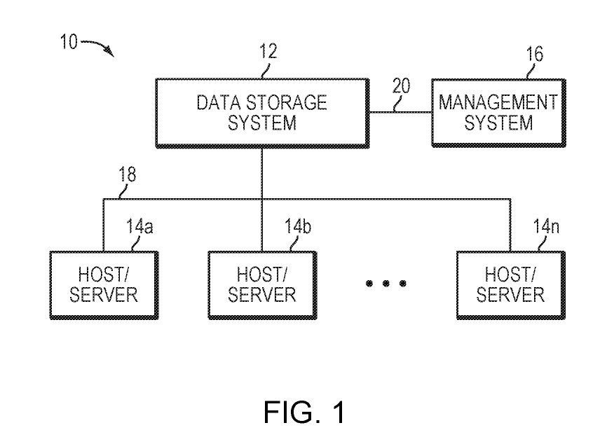

Referring now to FIG. 1, shown is an example of an embodiment of a computer system that may be used in connection with performing the technique or techniques described herein. The computer system 10 includes one or more data storage systems 12 connected to host systems 14a-14n through communication medium 18 (such as back-end and frontend communication medium). The system 10 also includes a management system 16 connected to one or more data storage systems 12 through communication medium 20. In this embodiment of the computer system 10, the management system 16, and the N servers or hosts 14a-14n may access the data storage systems 12, for example, in performing input/output (I/O) operations, data requests, and other operations. The communication medium 18 may be any one or more of a variety of networks or other type of communication connections as known to those skilled in the art. Each of the communication mediums 18 and 20 may be a network connection, bus, and/or other type of data link, such as hardwire or other connections known in the art. For example, the communication medium 18 may be the Internet, an intranet, network or other wireless or other hardwired connection(s) by which the host systems 14a-14n may access and communicate with the data storage systems 12, and may also communicate with other components (not shown) that may be included in the computer system 10. In at least one embodiment, the communication medium 20 may be a LAN connection and the communication medium 18 may be an iSCSI or SAN through Fibre Channel connection.

Each of the host systems 14a-14n and the data storage systems 12 included in the computer system 10 may be connected to the communication medium 18 by any one of a variety of connections as may be provided and supported in accordance with the type of communication medium 18. Similarly, the management system 16 may be connected to the communication medium 20 by any one of variety of connections in accordance with the type of communication medium 20. The processors included in the host computer systems 14a-14n and management system 16 may be any one of a variety of proprietary or commercially available single or multi-processor system, such as an Intel-based processor, or other type of commercially available processor able to support traffic in accordance with each particular embodiment and application.

It should be noted that the particular examples of the hardware and software that may be included in the data storage systems 12 are described herein in more detail, and may vary with each particular embodiment. Each of the host computers 14a-14n, the management system 16 and data storage systems may all be located at the same physical site, or, alternatively, may also be located in different physical locations. In connection with communication mediums 18 and 20, a variety of different communication protocols may be used such as SCSI, Fibre Channel, iSCSI, FCoE and the like. Some or all of the connections by which the hosts, management system, and data storage system may be connected to their respective communication medium may pass through other communication devices, such as a connection switch or other switching equipment that may exist such as a phone line, a repeater, a multiplexer or even a satellite. In at least one embodiment, the hosts may communicate with the data storage systems over an iSCSI or Fibre Channel connection and the management system may communicate with the data storage systems over a separate network connection using TCP/IP. It should be noted that although FIG. 1 illustrates communications between the hosts and data storage systems being over a first connection, and communications between the management system and the data storage systems being over a second different connection, an embodiment may also use the same connection. The particular type and number of connections may vary in accordance with particulars of each embodiment.

Each of the host computer systems may perform different types of data operations in accordance with different types of tasks. In the embodiment of FIG. 1, any one of the host computers 14a-14n may issue a data request to the data storage systems 12 to perform a data operation. For example, an application executing on one of the host computers 14a-14n may perform a read or write operation resulting in one or more data requests to the data storage systems 12.

The management system 16 may be used in connection with management of the data storage systems 12. The management system 16 may include hardware and/or software components. The management system 16 may include one or more computer processors connected to one or more I/O devices such as, for example, a display or other output device, and an input device such as, for example, a keyboard, mouse, and the like. A data storage system manager may, for example, view information about a current storage volume configuration on a display device of the management system 16. The manager may also configure a data storage system, for example, by using management software to define a logical grouping of logically defined devices, referred to elsewhere herein as a storage group (SG), and restrict access to the logical group.

It should be noted that although element 12 is illustrated as a single data storage system, such as a single data storage array, element 12 may also represent, for example, multiple data storage arrays alone, or in combination with, other data storage devices, systems, appliances, and/or components having suitable connectivity, such as in a SAN, in an embodiment using the techniques herein. It should also be noted that an embodiment may include data storage arrays or other components from one or more vendors. In subsequent examples illustrated the techniques herein, reference may be made to a single data storage array by a vendor, such as by EMC Corporation of Hopkinton, Mass. However, as will be appreciated by those skilled in the art, the techniques herein are applicable for use with other data storage arrays by other vendors and with other components than as described herein for purposes of example.

An embodiment of the data storage systems 12 may include one or more data storage systems. Each of the data storage systems may include one or more data storage devices, such as disks. One or more data storage systems may be manufactured by one or more different vendors. Each of the data storage systems included in 12 may be inter-connected (not shown). Additionally, the data storage systems may also be connected to the host systems through any one or more communication connections that may vary with each particular embodiment and device in accordance with the different protocols used in a particular embodiment. The type of communication connection used may vary with certain system parameters and requirements, such as those related to bandwidth and throughput required in accordance with a rate of I/O requests as may be issued by the host computer systems, for example, to the data storage systems 12.

It should be noted that each of the data storage systems may operate stand-alone, or may also be included as part of a storage area network (SAN) that includes, for example, other components such as other data storage systems.

Each of the data storage systems of element 12 may include a plurality of disk devices or volumes. The particular data storage systems and examples as described herein for purposes of illustration should not be construed as a limitation. Other types of commercially available data storage systems, as well as processors and hardware controlling access to these particular devices, may also be included in an embodiment.

Servers or host systems, such as 14a-14n, provide data and access control information through channels to the storage systems, and the storage systems may also provide data to the host systems also through the back-end and frontend communication medium. The host systems do not address the disk drives of the storage systems directly, but rather access to data may be provided to one or more host systems from what the host systems view as a plurality of logical devices or logical volumes. The logical volumes may or may not correspond to the actual disk drives. For example, one or more logical volumes may reside on a single physical disk drive. Data in a single storage system may be accessed by multiple hosts allowing the hosts to share the data residing therein. A LUN (logical unit number) may be used to refer to one of the foregoing logically defined devices or volumes. An address map kept by the storage array may associate host system logical address with physical device address.

In such an embodiment in which element 12 of FIG. 1 is implemented using one or more data storage systems, each of the data storage systems may include code thereon for performing the techniques as described herein. In following paragraphs, reference may be made to a particular embodiment such as, for example, an embodiment in which element 12 of FIG. 1 includes a single data storage system, multiple data storage systems, a data storage system having multiple storage processors, and the like. However, it will be appreciated by those skilled in the art that this is for purposes of illustration and should not be construed as a limitation of the techniques herein. As will be appreciated by those skilled in the art, the data storage system 12 may also include other components than as described for purposes of illustrating the techniques herein.

The data storage system 12 may include any one or more different types of disk devices such as, for example, an SATA disk drive, FC disk drive, and the like. Thus, the storage system may be made up of physical devices with different physical and performance characteristics (e.g., types of physical devices, disk speed such as in RPMs), RAID levels and configurations, allocation of cache, processors used to service an I/O request, and the like.

In certain cases, an enterprise can utilize different types of storage systems to form a complete data storage environment. In one arrangement, the enterprise can utilize both a block based storage system and a file based storage hardware, such as a VNX™, VNXe™, or Unity™ system (produced by EMC Corporation, Hopkinton, Mass.). In such an arrangement, typically the file based storage hardware operates as a front-end to the block based storage system such that the file based storage hardware and the block based storage system form a unified storage system such as Unity systems.

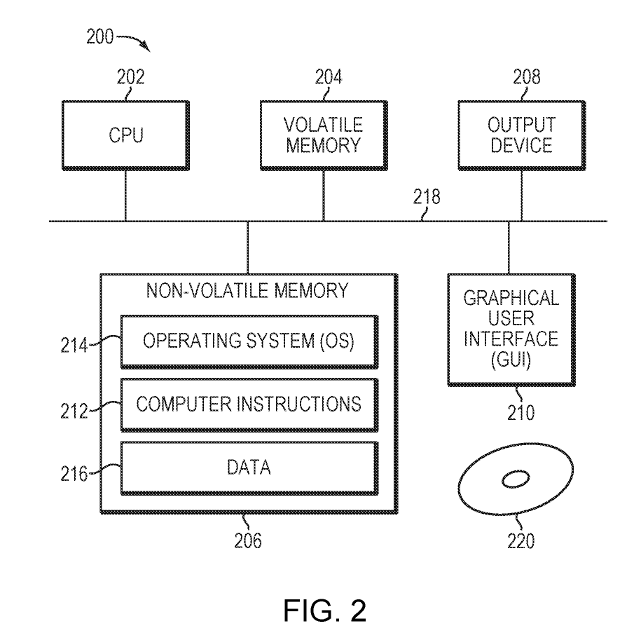

FIG. 2 illustrates a block diagram of a computer 200 that can perform at least part of the processing described herein, according to one embodiment. The computer 200 may include a processor 202, a volatile memory 204, a non-volatile memory 206 (e.g., hard disk), an output device 208 and a graphical user interface (GUI) 210 (e.g., a mouse, a keyboard, a display, for example), each of which is coupled together by a bus 218. The non-volatile memory 206 may be configured to store computer instructions 212, an operating system 214, and data 216. In one example, the computer instructions 212 are executed by the processor 202 out of volatile memory 204. In one embodiment, an article 220 comprises non-transitory computer-readable instructions. In some embodiments, the computer 200 corresponds to a virtual machine (VM). In other embodiments, the computer 200 corresponds to a physical computer.

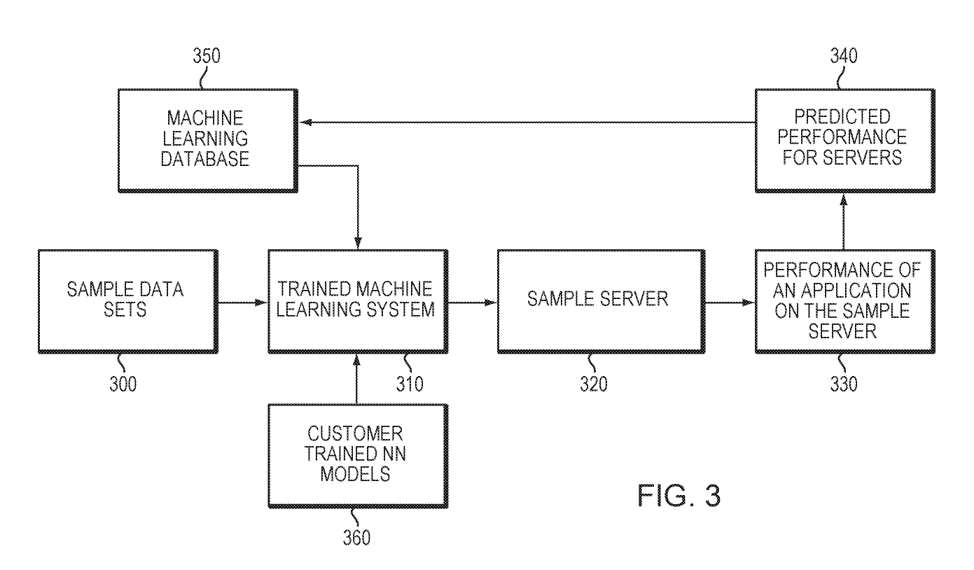

FIG. 3 illustrates an example process to train the machine learning system, according to one embodiment of the current technique. In an example embodiment, the machine learning system 310 is trained using sample data sets 300, by assessing the performance of the cores of the storage processors residing on a sample server 300. The machine learning system may also be trained with machine learning models provided by a machine learning database 350, and by customer trained NN models 360 if the customers choose to share the customer trained NN models 360. In an example embodiment, benchmark results from performance testing may be used to train a machine learning system, such as a neural network (NN) model, by providing as input to the machine learning system information such as CPU utilization of each core of a multi-core processor of a system and performance data such the number of I/O operations performed per second, throughput for I/O operations, read and write times for such I/O operations, percentage of read/write operations, I/O size, the number of cores, and whether compression and deduplication has been enabled. Such machine learning system may provide as output the number of IOPS achieved/measured by the test, number of machines/systems/virtual machines served (e.g., performance benchmark applications; fixed ratio of IOPS), compression ratio measured by the benchmark testing, deduplication ratio measured by the benchmark testing, throughput measured during the benchmarking (e.g., in MB/sec), and the response time achieved by the benchmark sample.

In an example embodiment, before each new release of an application, the quality assurance (QA) performance of the application is evaluated on at least one platform, for example, a sample server 320 that has a new or updated version of an application. The performance of the application is measured on the sample server 330. The trained machine learning system is then able to predict the performance 340 for servers other than the sample server. The predicted performance may then become one of the NN models in the machine learning database 350.

The QA testing may measure workloads, I/O sizes, various failure scenarios, etc. The machine learning system is trained using a data set of the QA performance for multiple platforms to create, for example, a NN model for each of the different types of platforms. The platforms selected may be the more powerful platforms. The machine learning system is comprised of the created NN models. Based on this extensive training set of NN models, the trained machine learning system will be able to predict the performance of an application for any other workload executing in a customer's computing environment, for example. In an example embodiment, the trained machine learning system is able to predict the application performance for any platform, with any number of cores. In an example embodiment, the trained machine learning system is able to predict the application performance for software defined storage (SDS), for example, hyper-converged infrastructure (HCl), whether the SDS runs on a hardware server or a virtual server.

As customers run the trained learning machine system on their platforms, the originally NN model provided to the customers is transformed into a customer trained NN model that the customers may choose to share to further train the machine learning system. With each new application release, the customers may use their existing customer trained NN model, or the customers may begin to train a new NN model, for example, the NN model that is provided with each new application release.

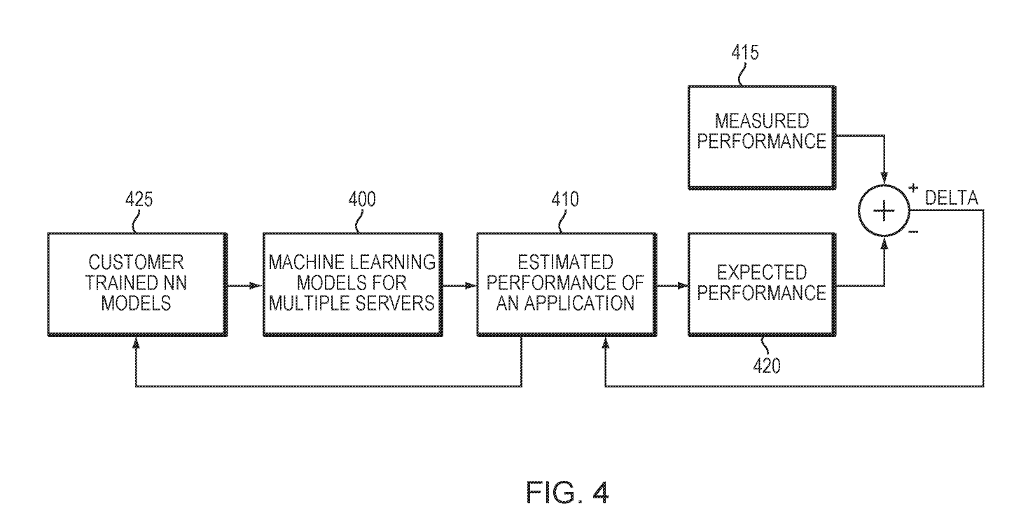

FIG. 4 illustrates an example process to train a customer application model, in accordance with an embodiment of the current technique. In an example embodiment, the customer receives a machine learning system comprised of NN models that were created for various types of platforms, machine learning models for multiple servers 400. For example, the method trains a machine learning system on multiple sample server executing at least one application. From the NN models, the performance of the customer's applications is predicted 410. For example, the method predicts the expected performance of the application on the server without having to actually measure a performance of the application on the server. The measured performance 415 is compared to the predicted/estimated performance 420. For example, once the application is installed on the customer's system, a measured performance may be compared to the expected performance to determine how to adjust the parameters (e.g., configuration parameters) for particular platforms to optimize performance and/or behavior of the application. The customer trained NN model 425 (also 360 in FIG. 3) is updated with this information. For example, as the customer uses the trained model on their own system, they effectively create a new model, the customer trained NN model. In an example embodiment, the customer may choose to share the customer trained NN so that the machine learning models for multiple servers also include the customer trained NN.

The NN model allows the customers to test out new features and new applications even before the new features and applications are implemented or installed on the customer's system. Thus, if the customer detects problems with any new features and/or applications, the customers can provide this feedback. With this feedback, the problems may be addressed prior to the customer installing the new features and applications on their system. Thus, when the customer does install the new features and applications on their system, the customer will know what should be the performance for such new features and applications.

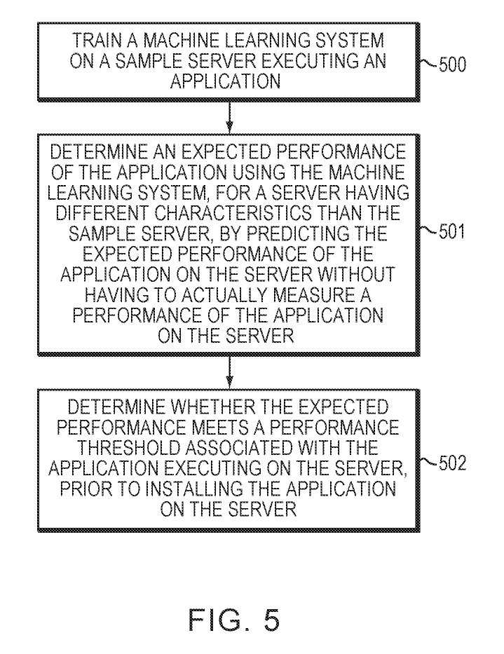

Referring to FIG. 5, shown is a more detailed flow diagram illustrating predicting performance of applications using machine learning systems. With reference also to FIGS. 1-4, the method trains a machine learning system on a sample server executing an application (Step 500). The machine learning system is trained to learn the impact the application has on performance of the sample server, for example, to determine if the platform has enough compute resources to prevent performance degradation of the sample server, and reduced data reduction savings when the application is executing. In an example embodiment, the method trains the machine learning system on a variety of platforms. For each platform, a NN model is created. In an example embodiment, the application is optimized for the platform(s) on which the application is executed.

The method determines an expected performance of the application using the machine learning system, for a server having different characteristics than the sample server, by predicting the expected performance of the application on the server without having to actually measure a performance of the application on the server (Step 501). In an example embodiment, the server having different characteristics than the sample server has at least one of different hardware characteristics and different software characteristics than the sample server. In an example embodiment, the machine learning system is comprised of NN models, where each NN model is created by executing the application on a sample server or, for example, different sample servers. The different sample servers may each reside on a different platform, for example, the more powerful platforms. The different sample servers may represent different supported hardware configurations and platforms and different supported back-end and frontend communication medium supported by each hardware platform. From the NN models, the method estimates/extrapolates the expected performance of the application executing on the server or, for example, several servers. The several servers may each reside on a different platform, for example, the less powerful platforms. In an example embodiment, the application is optimized for the platform(s) on which the application is executed when creating the NN model, yet that application may execute on many other types of platforms with, for example, a different number of cores, different size of memory, different network, and/or different backend communication medium. Since it is not feasible to test and/or optimize the application on the wide variety of hardware and software platforms and configurations, the method determines an expected performance of the application using the machine learning system for a server having different characteristics than the sample server on which the NN model was created. Thus, the method may test the application and/or new features on a few select platforms, and estimate the behavior of the applications and/or new features on all types of platforms. In other words, the method predicts the expected performance of the application on the server without having to actually measure a performance of the application on the server. For example, a customer may execute an application on a cluster file server where the application performs poorly because the application is not optimized for I/Os to a cluster file server, but rather optimized for I/Os to a local disk. A NN model trained for executing the application on a cluster file server may predict the application's behavior on such cluster file server, and allow adjusting performance of the application to optimize execution of such application on the cluster file server.

Additionally, to test out a new application and/or new features, the customer may execute the NN model for a brief period of time to analyze the performance, rather than installing the new applications and/or new features and testing for long periods of time, only to determine that the applications and/or new features produce a poor performance.

In an example embodiment, the method determines whether the expected performance meets a performance threshold associated with the application executing on the server, prior to installing the application on the server (Step 502). As illustrated in FIG. 4, the method allows customers to predict performance of new applications and features on their platforms, using the customer's workload, without having to actually install the new applications and features. The customers can determine whether the expected performance provided by the NN model meets the customers' expectations.

In an example embodiment, the method provides information to modify the application based on the expected performance of the application. In an example embodiment, the customers may provide feedback to developers of the applications and new features based on the performance of the NN model executing on the customer's server. For example, customers may provide performance data to developers that developers would not otherwise be able to create, thus allowing the developers to continue to adjust performance of the application prior to the customers installing the application on the customer systems. In another example embodiment, the NN model that is created on the sample server(s), for example, the more powerful platforms, may be repurposed, and used to assist developers to adjust performance of the application and new features specifically for each platform. The developers may add hooks in the code to allow optimizations of applications on less powerful platforms, without the need for the developers to measure the performance of applications and new features on all the platforms.

In an example embodiment, the method compares the expected performance to a measured performance of the application executing on the server. As illustrated in FIG. 4, the method compares the expected performance to the measured performance of the application executing on the server and this data may continually train the NN model on the customer's server. In an example embodiment, the customer may choose to share the customer trained NN model to train other machine learning systems. In another example embodiment, additional benchmark testing data sets may be added to the customer trained NN model.

In an example embodiment, the method updates parameters associated with the application to adjust performance of the application according to the expected performance. Typically, there exist parameters that may be used to adjust performance of individual servers or storage arrays. The performance of the individual servers may depend on the individual server as well as the I/O performance of any off-the-shelf applications that the customer may install on the individual server. The off-the-shelf applications may utilize the storage and disk in a poor manner, affecting overall performance. In response, customers may complain about the individual server's performance when the true cause of the problem with the server is badly configured off-the-shelf applications. According to embodiments disclosed herein, the vendors of the off-the-shelf applications may test these applications on a few platforms, and optimize performance of their applications for all platforms for which there is a NN model available. Additionally, customers who have installed the off-the-shelf applications on their servers may execute the NN model on their servers to obtain optimal performance for the off-the-shelf applications. As the customers continue to run the NN model on their systems, the NN model may be transformed into a customer trained NN model. The customer trained NN model may be used to test various applications' expected performance. When those applications are installed on the customer systems, the NN model may be used to optimize the performance of those applications.

In an example embodiment, there exist internal parameters, such as a buffer cache parameter, that may be modified by a customer. For example, to optimize performance, the buffer cache parameter may be configured to different values depending on the size of the platform. Embodiments disclosed herein enable the customer to adjust the parameter to optimize the performance according to the size of the customer's platform.

In an example embodiment, the customer may automatically adjust the storage parameters according to the application output to optimize the use of the application. In another example embodiment, when a customer plans to upgrade the hardware of the customer's system to a new server platform, the customer may use the NN model, as illustrated in FIG. 4, to estimate the performance and storage access of the new server platform prior to the new server platform upgrade. The customer may then request upgrades, such as software upgrades, to obtain the expected performance. This enables the customer to minimize the impact of the platform upgrade as well as achieve a better performance, for example, faster Input/output operations per second (IOPS), when the new server is installed.

In an example embodiment, the method continues to train the machine learning system using the measured performance. In an example embodiment, as the NN model runs on a platform, and learns the behavior of new applications and/or new features, the method continues to train the machine learning system.

In an example embodiment, the method trains the machine learning system with performance testing data associated with the application gathered during execution of the application on a second server. As illustrated in FIG. 4, as customers execute the trained learning machine system on their platforms, the original NN model provided to the customers is transformed into a customer trained NN model. With each new application release, the customers may use their existing customer trained NN model, or the customers may begin to train a new NN model, for example, the NN model that is provided with each new application release. In other words, the original model provided to the customer is trained on the sample server. As the customer uses the trained model on their own system, they effectively create a new model. Thus, their own system is the second server.

In an example embodiment, the method includes at least one parameter when determining the expected performance of the application, wherein at least one parameter was not included when the application was executing on the sample server. In an example embodiment, a customer may add at least one parameter when the NN model is trained on the customer's platform. For example, a customer may add a feature such as inline compression or inline deduplication, requiring an additional measurement of the customer application performance to be captured while the customer trains the NN model. This additional feature adds a new measurement and changes the number of parameters. In this example scenario, the customer may re-train the NN model to include the updated estimated customer application performance that includes the additional measurement. In an example embodiment, if the customer chooses to share the customer application trained NN model, then the NN models in the machine learning models database (as illustrated in FIG. 3) may be modified to include the additional parameter.

There are several advantages to embodiments disclosed herein. For example, the method trains a machine learning system on a few platforms, where the machine learning system can extrapolate the performance of an application for a wider variety of platforms. The method provides a machine learning system that predicts the performance of an application on a platform even when the application has not yet been installed on the platform. The method provides trained machine learning systems that customers can continue to train on the customer systems.

It should again be emphasized that the technique implementations described above are provided by way of illustration, and should not be construed as limiting the present invention to any specific embodiment or group of embodiments. For example, the invention can be implemented in other types of systems, using different arrangements of processing devices and processing operations. Also, message formats and communication protocols utilized may be varied in alternative embodiments. Moreover, various simplifying assumptions made above in the course of describing the illustrative embodiments should also be viewed as exemplary rather than as requirements or limitations of the invention. Numerous alternative embodiments within the scope of the appended claims will be readily apparent to those skilled in the art.

Furthermore, as will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method of predicting performance of applications using machine learning systems, the method comprising:
training a machine learning system on a sample server executing an application; and
determining an expected performance of the application using the machine learning system, for a server having different characteristics than the sample server, by predicting the expected performance of the application on the server without having to actually measure a performance of the application on the server.

2. The method of claim 1, further comprising:
determining whether the expected performance meets a performance threshold associated with the application executing on the server, prior to installing the application on the server.

3. The method of claim 1, further comprising:
providing information to modify the application based on the expected performance of the application.

4. The method of claim 1, further comprising:
comparing the expected performance to a measured performance of the application executing on the server.

5. The method of claim 4, further comprising:
updating configuration parameters associated with the application to adjust performance of the application according to the expected performance.

6. The method of claim 4, further comprising:
continuing to train the machine learning system using the measured performance.

7. The method of claim 1, further comprising:
training the machine learning system with performance testing data associated with the application gathered during execution of the application on a second server.

8. The method of claim 1, wherein the server having different characteristics than the sample server has at least one of different hardware characteristics and different software characteristics than the sample server.

9. The method of claim 1, further comprising:
including at least one parameter when determining the expected performance of the application, wherein the at least one parameter was not included when the application was executing on the sample server.

10. A system for use in predicting performance of applications using machine learning systems, the system comprising a processor configured to:
train a machine learning system on a sample server executing an application; and
determine an expected performance of the application using the machine learning system, for a server having different characteristics than the sample server, by predicting the expected performance of the application on the server without having to actually measure a performance of the application on the server.

11. The system of claim 10, further configured to:
determine whether the expected performance meets a performance threshold associated with the application executing on the server, prior to installing the application on the server.

12. The system of claim 10, further configured to:
provide information to modify the application based on the expected performance of the application.

13. The system of claim 10, further configured to:
compare the expected performance to a measured performance of the application executing on the server.

14. The system of claim 13, further configured to:
update configuration parameters associated with the application to adjust performance of the application according to the expected performance.

15. The system of claim 13, further configured to:
continue to train the machine learning system using the measured performance.

16. The system of claim 10, further configured to:
train the machine learning system with performance testing data associated with the application gathered during execution of the application on a second server.

17. The system of claim 10, wherein the server having different characteristics than the sample server has at least one of different hardware characteristics and different software characteristics than the sample server.

18. The system of claim 10, further configured to:
include at least one parameter when determining the expected performance of the application, wherein the at least one parameter was not included when the application was executing on the sample server.

19. A computer program product for predicting performance of applications using machine learning systems, the computer program product comprising:
a computer readable storage medium having computer executable program code embodied therewith, the program code executable by a computer processor to:
train a machine learning system on a sample server executing an application; and
determine an expected performance of the application using the machine learning system, for a server having different characteristics than the sample server, by predicting the expected performance of the application on the server without having to actually measure a performance of the application on the server.

20. The computer program product of claim 19, the program code further configured to:
determine whether the expected performance meets a performance threshold associated with the application executing on the server, prior to installing the application on the server.
